(19) United States
(12) Patent Application Publication
(10) Pub. No.: US 2005/0253450 A1
(43) Pub. Date: Nov. 17, 2005

(54) Electromechanical brake pressure generator for a motor vehicle brake system and motor vehicle brake system

(76) Inventors: Wilfried Giering, Mendig (DE); Benedikt Ohlig, Vallendar (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/130,840

(22) Filed: May 17, 2005

(30) Foreign Application Priority Data
May 17, 2004 (DE) 10 2004 024 404.9

(51) Int. Cl. B60T 8/42; F16D 65/00

(52) U.S. Cl. 303/115.1; 188/73.1

(57) ABSTRACT

In an electromechanical brake pressure generator (10) for a motor vehicle brake system with a force input member (12), which is coupled to a brake pedal, a housing (14) and a pressure piston (20) which can be displaced in the housing (14), wherein the pressure piston (20) encloses, with the housing (14), a pressure chamber (22) for generating a hydraulic brake pressure, and a threaded spindle-threaded nut arrangement (26), one component (28) of which can be displaced in order to displace the pressure piston (20) relative to the housing (14), and the other component (30) of which can be rotatably driven in the housing (14), wherein the component (28) of the threaded spindle-threaded nut arrangement (26) which co-operates with the pressure piston (20) can be displaced in order to displace the pressure piston (20) according to a displacement of the force input member (12) by rotatably driving the rotatably drivable component (30) of the threaded spindle-threaded nut arrangement (26) in order to generate a hydraulic brake pressure in the pressure chamber (22), the component (28) of the threaded spindle-threaded nut arrangement (26) which co-operates with the pressure piston (20) and the pressure piston (20) can only be workingly coupled together directly after overcoming a coupling clearance (s₁) against the action of a spring force in order to prevent a jerky operation.

The invention relates to an electromechanical brake pressure generator for a motor vehicle brake system with a force input member, which is coupled to a brake pedal, a housing and a pressure piston which can be displaced in the housing, wherein the pressure piston encloses, with the housing, a pressure chamber for generating a hydraulic brake pressure, and a threaded spindle-threaded nut arrangement, one component of which can be displaced in order to displace the pressure piston relative to the housing, and the other component of which can be rotatably driven in the housing, wherein the component of the threaded spindle-threaded nut arrangement which co-operates with the pressure piston can be displaced in order to displace the pressure piston according to a displacement of the force input member by rotatably driving the rotatably drivable component of the threaded spindle-threaded nut arrangement in order to generate a hydraulic brake pressure in the pressure chamber.

An electromechanical braking force generator of this kind is known, for example, from U.S. Pat. No. 4,918,921. An electric motor is activated according to an actuation of a brake pedal in the case of this braking force generator. Here the rotor of the electric motor is non-rotatably coupled to the threaded nut of a ball screw. The threaded spindle of the ball screw is held in the threaded nut and secured against rotation in the housing, yet can be displaced in translatory fashion upon rotating the threaded nut. It is therefore possible to displace a brake piston for generating a brake pressure inside the housing through a translatory displacement of the threaded spindle. The spindle is introduced into an end opening of the pressure piston and lies snugly in this opening in the arrangement known from this prior art. This means that, on account of a clearance in the threaded spindle-threaded nut arrangement, the threaded spindle is not initially displaced when the electric motor is activated, although subsequently—as soon as the clearance is used up—the threaded spindle and the pressure piston, which is directly coupled to the latter, are abruptly displaced. This may lead to an undesirable impact load in the overall system, which on the one hand results in an abrupt braking action, to which the driver is not accustomed, and on the other may entail undesirable wear effects in the threaded spindle-threaded nut arrangement.

A similar arrangement is known from U.S. Pat. No. 4,653,815. The threaded nut is rotatably driven by means of an electric motor via an external tooth system in this braking force generator. The threaded spindle is again directly coupled to the pressure piston. The clearance inherent in the system is again initially used up in this arrangement as a result of the electric motor being activated and the threaded nut rotatably driven. Once the clearance has been used up, the system is again subjected to an impact load which on the one hand leads to an abrupt displacement of the pressure piston and on the other to undesirable wear effects at the threaded spindle-threaded nut arrangement.

DE 102 55 198 A1 discloses an electromechanical brake pressure generator in which the threaded spindle is held so as to be secured against rotation in the housing and can be displaced by rotating the threaded spindle relative to the housing by means of a motor drive. The brake pressure piston is directly coupled to the threaded nut, which can be displaced in translatory fashion, in the case of this prior art. This arrangement is also subject to the abrupt impact loads mentioned above as a result of the electric motor being activated and the resultant negative consequences of an increase in wear and an abrupt initiation of the braking operation, to which the driver is not accustomed.

Finally, an electromechanical brake pressure generator in which the support takes place by means of a coupling arrangement is known from DE 30 31 643 C2.

In contrast, an object of the present invention is to provide an electromechanical brake pressure generator of the type initially indicated in which an abrupt displacement of the pressure piston and impact loads resulting from this are eliminated.

This object is solved by an electromechanical brake pressure generator having the features of the preamble of claim 1, in which the component of the threaded spindle-threaded nut arrangement which co-operates with the pressure piston and the pressure piston can only be workingly coupled together directly after overcoming a coupling clearance against the action of a spring force.

By means of the measure according to the invention it is possible to prevent a displacement of the component of the threaded spindle-threaded nut arrangement which co-operates with the pressure piston with continuously increasing intensity from being transmitted to the pressure piston, while preventing impact loads, and therefore the disadvantages described in relation to the prior art. The coupling clearance is in particular firstly overcome against the action of the spring force, with the component of the threaded spindle-threaded nut arrangement which co-operates with the pressure piston displacing the latter in a smoothly increasing manner as the spring force increases. Only when the coupling clearance is completely used up is the movement directly transmitted to the pressure piston.

The expression “brake pressure generator” which is used within the scope of the description and the claims relating to the present invention is intended to cover both an arrangement in which a fluid pressure is generated in the pressure chamber via a brake pedal, a brake booster and a master brake cylinder connected thereto, and an arrangement in which a brake pedal actuation is detected and, according to this, a fluid pressure is then generated in the pressure chamber without directly utilising the pedal actuating force which is exerted on the brake pedal. The expression “brake pressure generator” is also intended to cover arrangements which only use the pedal actuating force which is exerted on the brake pedal in part or only in certain (emergency) operating situations.

In one development of the invention a spring arrangement is provided between the component of the threaded spindle-threaded nut arrangement which co-operates with the pressure piston and the pressure piston, wherein the coupling clearance can be overcome against the spring force of the spring arrangement. The spring arrangement preferably comprises a Belleville spring assembly in this case. It is, however, alternatively possible to use spring arrangements of a different type such as, for example, helical compression springs or elastomer spring elements, in particular of hard rubber material.

According to one constructional variant of the invention, the component of the threaded spindle-threaded nut arrangement which co-operates with the pressure piston is formed with an impact shoulder which, after overcoming the coupling clearance, comes into working contact with the pressure piston or a construction element which is workingly coupled to the pressure piston. The coupling clearance can easily be provided through this measure.

In one development of the brake pressure generator according to the invention the component of the threaded spindle-threaded nut arrangement which co-operates with the pressure piston is constituted by the threaded spindle.

As already indicated at the beginning, it is possible according to the invention for the pedal actuating force which is exerted on the force input member via the brake pedal to be introduced directly into the pressure piston. In an arrangement of this kind the threaded spindle-threaded nut arrangement then acts as braking force assistance and boosts the pedal actuating force which is exerted on the brake pedal. In one development of the invention, given a constructional variant of this kind, the force input member is or can be coupled to the pressure piston in order to displace this.

According to the invention, a buffer clearance may also be provided in the transmission path between the force input member and the pressure piston, wherein the force input member and the pressure piston can only be workingly coupled together after overcoming the buffer clearance. This measure is in particular necessary because the rotary drive of the threaded spindle-threaded nut arrangement may not react quickly enough when the brake pedal is actuated very quickly, so that a braking force generation which is available through the threaded spindle-threaded nut arrangement and the rotary drive associated with this during normal operation and which is expected by the driver is not provided. The driver then has the impression that he is pushing against an unusually strong resistance. This impression may cause the driver to interpret the unusual behaviour of the motor vehicle brake system as failure. This can be prevented by the above-mentioned measure of providing a buffer clearance. The buffer clearance is as a result firstly overcome when the brake pedal is actuated very quickly. However, even if the brake peal is actuated very quickly, the period in which the buffer clearance is overcome is sufficiently long, so that a braking force is generated via the rotary drive and the threaded spindle-threaded nut arrangement and the driver thus experiences the behaviour of the motor vehicle brake system with which he is familiar.

According to one development of this embodiment according to the invention, a buffer spring arrangement is also associated with the buffer clearance, wherein the buffer clearance can be overcome against the spring force of the buffer spring arrangement. Belleville spring assemblies, helical compression springs or elastomer bodies may also be used for the buffer spring arrangement.

In one development of the invention the force input member and the pressure piston can be coupled together via a transmission piston. This measure opens up various possibilities for the arrangement of the buffer clearance and optionally of the buffer spring arrangement. Therefore, according to one constructional variant, the buffer clearance and the buffer spring arrangement may be disposed between the force input member and the transmission piston. This means that the transmission piston is displaced with a delay and then transmits this delayed displacement to the pressure piston. However it is alternatively also possible for the buffer clearance and the buffer spring arrangement to be disposed between the transmission piston and the pressure piston. This means that the transmission piston is coupled substantially rigidly to the force input member and that the actuating force is transmitted to the pressure piston with a delay.

As regards the threaded spindle-threaded nut arrangement, in one development of the invention the component of the threaded spindle-threaded nut arrangement which co-operates with the pressure piston is guided so as to be secured against rotation relative to the housing, and, in order to form the anti-rotation mechanism, a region of the component of the threaded spindle-threaded nut arrangement which co-operates with the pressure piston is provided with a cylindrical guide profile which co-operates with a complementary profile which is fixed relative to the housing, wherein the base area of the guide profile is of a form which is such that the component of the threaded spindle-threaded nut arrangement which is guided in translatory fashion is supported at the complementary profile upon support forces being transmitted in a uniform distribution over the circumference of the cylindrical guide profile. The threaded spindle can thus be guided relative to the housing with low friction and low wear levels. The guide profile is in this case preferably provided with a polygonal base area.

The invention also relates to a motor vehicle brake system with an electromechanical brake pressure generator of the type described above.

The invention is illustrated by way of example in the following on the basis of the accompanying figures, in which:

FIG. 1 is a longitudinal sectional partial view of a first embodiment of the brake pressure generator according to the invention;

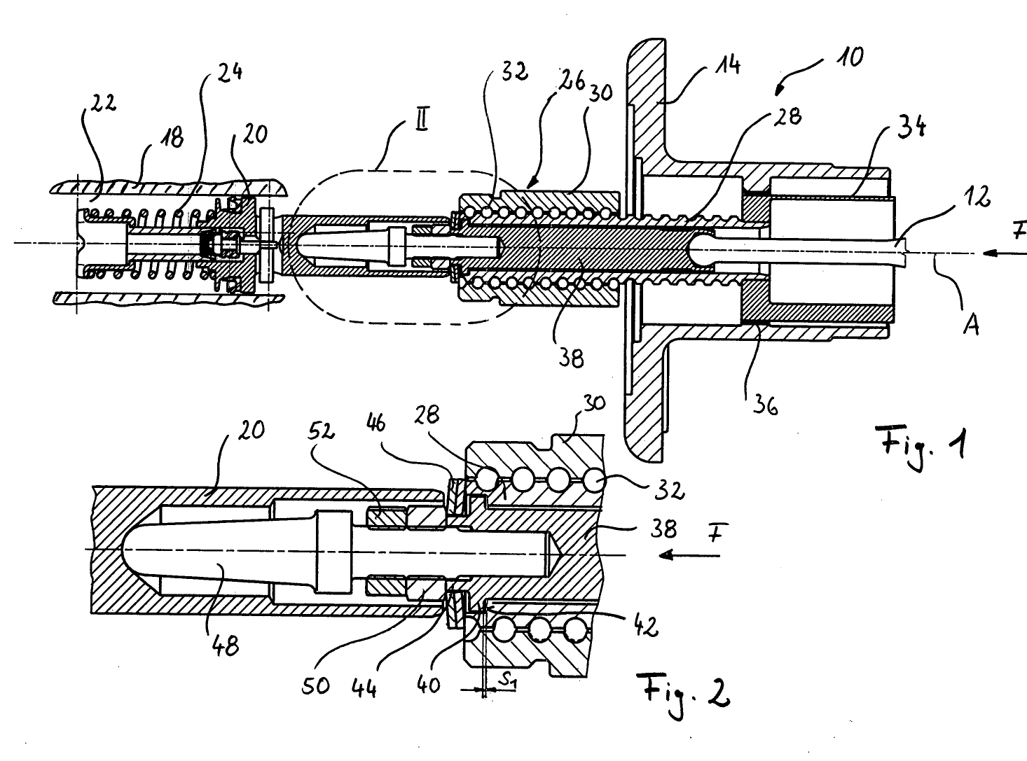

FIG. 2 is an enlarged representation of the region of the brake pressure generator according to the invention which is marked by II in FIG. 1;

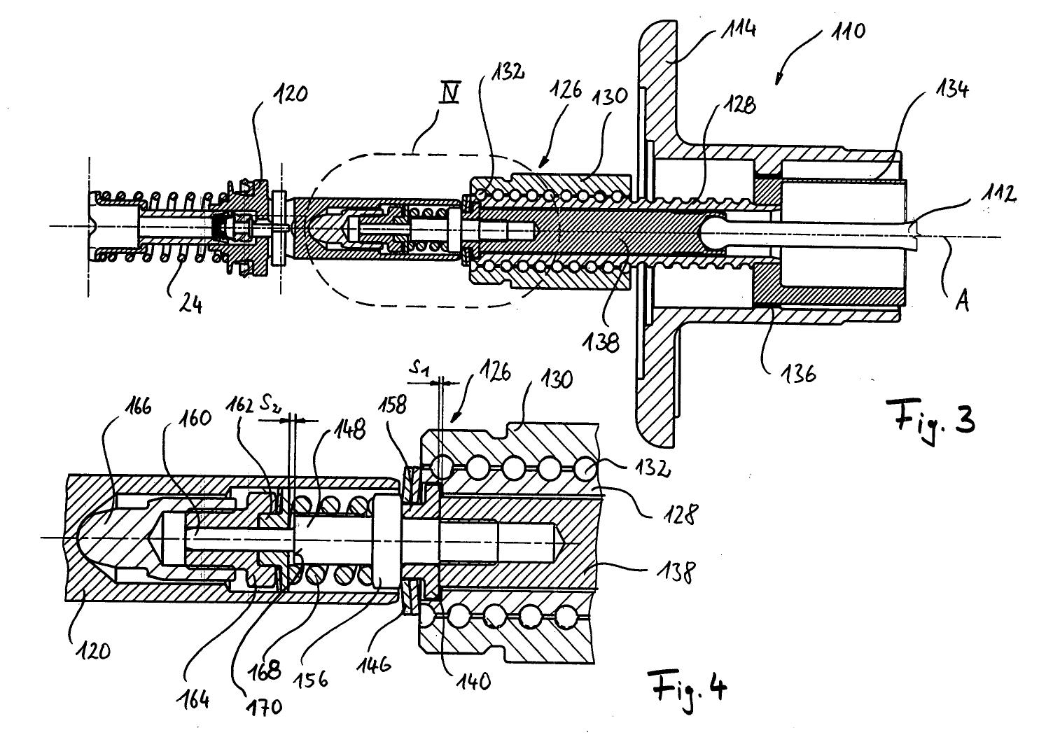

FIG. 3 is a longitudinal sectional partial view of a second embodiment of the brake pressure generator according to the invention;

FIG. 4 is an enlarged representation of the region of the brake pressure generator according to the invention which is marked by IV in FIG. 3;

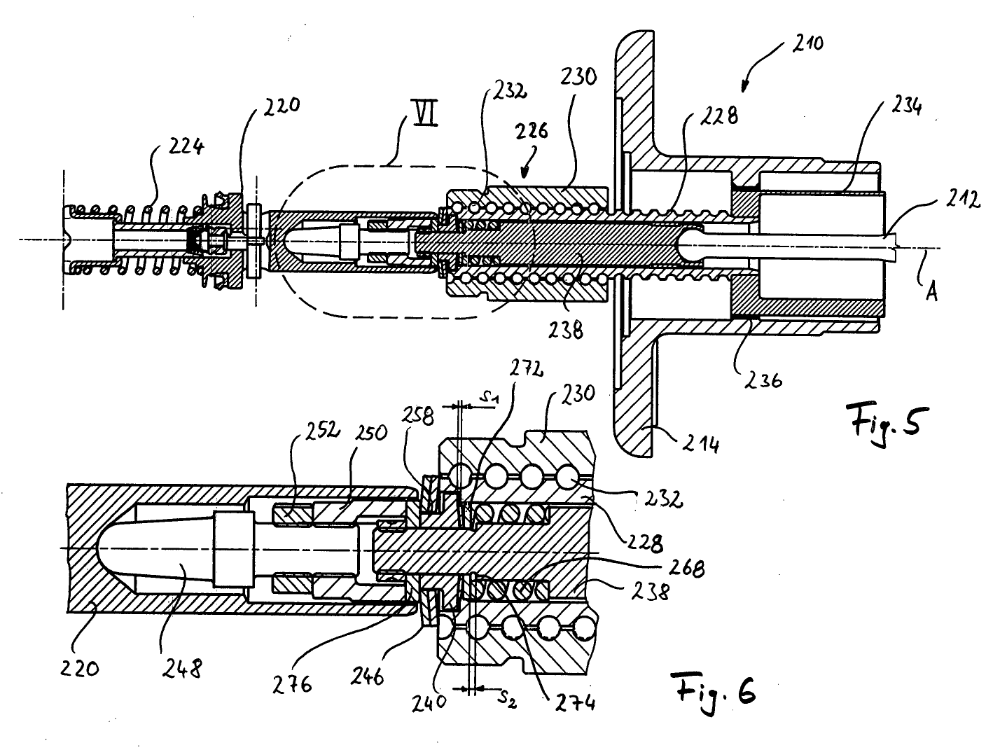

FIG. 5 is a longitudinal sectional partial view of a third embodiment of the brake pressure generator according to the invention;

FIG. 6 is an enlarged representation of the region of the brake pressure generator according to the invention which is marked by VI in FIG. 5;

FIG. 7 is a longitudinal sectional partial view of a fourth embodiment of the brake pressure generator according to the invention and

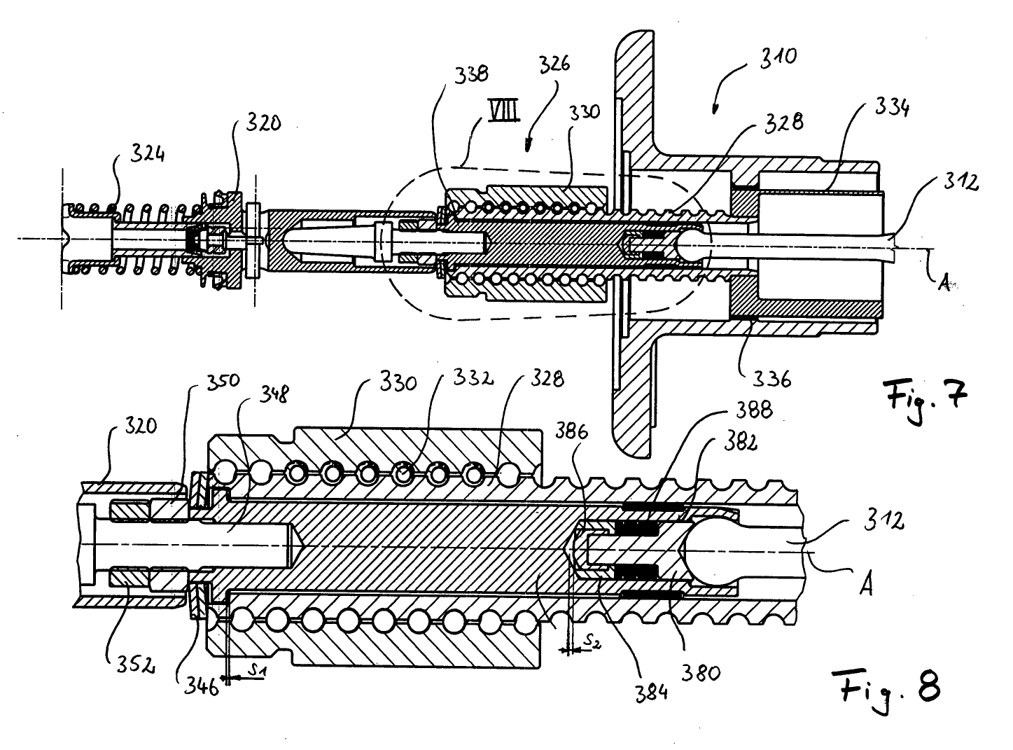

FIG. 8 is an enlarged representation of the region of the brake pressure generator according to the invention which is marked by VIII in FIG. 7.

A brake pressure generator according to the invention which is shown in a longitudinal sectional partial view is generally designated by 10. This comprises a force input member 12, which is coupled to a brake pedal, which is not shown. The force input member 12 is introduced by way of its end which is on the left in FIG. 1 into a housing 14, only part of which is shown. Rubber bellows, which are not shown, provide a dust-tight connection between the housing 14 and the force input member 12. A master brake cylinder 18, which is just schematically indicated and in which a pressure piston 20 is held, is formed at the end of the housing 14 which is remote from the force input member 12. The pressure piston 20 encloses, with the master brake cylinder 18 of the housing 14, a pressure chamber 22 in which a hydraulic brake fluid is held. The pressure chamber 22 also holds a spring arrangement 24, which biases the pressure piston 20 into a starting position.

A ball screw 26 is held in the housing 14 between the pressure piston 20 and the force input member 12. This ball screw comprises a threaded spindle 28 and a threaded nut 30. The threaded spindle 28 is formed with an axial through-bore into which the end of the force input member 12 which is on the left in FIG. 1 is introduced. A transmission piston 38 is held and mounted in an axially displaceable manner in the through-bore and holds at its end which is on the right in FIG. 1 the end of the force input member 12 which is on the left in FIG. 1 in order to transmit an input force F acting on the force input member 12.

The threaded nut 30 is mounted such that it can rotate in the housing 14, yet is secured against displacement along the axis A. The threaded nut 30 can be rotatably driven via a motorized drive, which is not shown. A plurality of rolling bodies 32 is disposed in a manner known per se in a cage between the threaded spindle 28 and the spindle nut 30.

If the end of the threaded spindle 28 which is on the right in FIG. 1 is considered, it can be seen that this is coupled to a guide sleeve 34, which guide sleeve 34 is firmly seated on the right-hand end of the threaded spindle 28. The guide sleeve 34 is held in a guide ring 36 which is made of a friction-reducing plastics material, i.e. of polytetrafluoroethylene, and which is retained in the housing 14 by local flared joints. The guide sleeve 34 and the guide ring 36 are formed such that the guide sleeve 34 and the guide ring 36 cannot be rotated relative to one another about the axis A.

If the left-hand end of the threaded spindle 28 which is shown in FIG. 1 and FIG. 2 is considered, it can be seen that the left-hand end of the transmission piston 38 projects out of the threaded spindle 28. The transmission piston 38 comprises an impact ring 40 which is formed integrally thereon and lies opposite a corresponding impact shoulder 42. A coupling clearance s₁ is provided in the starting position which is shown in FIGS. 1 and 2 between the impact ring 40 and the impact shoulder 42 of the threaded spindle 28. A diametrical step 44 is also provided at the left-hand end of the transmission piston 38, on which step a Belleville spring assembly 46 is disposed. An intermediate member 48 is disposed between the transmission piston 38 and the pressure piston 20. The intermediate member 48 is provided with an externally threaded portion, on which two lock nuts 50 and 52 are fixed. The lock nut 50 which is on the right in FIG. 2 lies against the end face of the left-hand end of the transmission piston 38. The intermediate member 48 is held by way of an end portion in the transmission piston 38.

The Belleville spring assembly 46 is supported on the one hand at the lock nut 50 and on the other at the end face of the left-hand end of the threaded spindle 28. The threaded spindle 28 can thereby only be displaced relative to the pressure piston 20 against the spring force of the Belleville spring assembly 46 within the coupling clearance 38.

During operation a brake pedal actuation is detected in sensory fashion, for example by a force sensor disposed in the region of the force input member 12. The pedal actuating force F which is exerted on the force input member 12 is also transmitted directly to the pressure piston 20. The electric motor, which is not shown, is activated according to the detected brake pedal actuation and initiates a rotational movement of the threaded nut 30. The threaded spindle 28, which is guided so as to be secured against rotation, is as a result displaced to the left in FIG. 1. However the threaded spindle 28 and the pressure piston 20 are not directly coupled immediately. The Belleville spring assembly 46 is instead firstly deformed under the movement of the threaded spindle 28 until the coupling clearance s₁ is used up. As soon as the coupling clearance s₁ is used up, the threaded spindle 28 bears workingly by way of its impact shoulder 42 against the impact ring 40, so that each further movement of the threaded spindle 28 to the left in FIGS. 1 and 2 is directly transmitted to the pressure piston 20. A hydraulic brake pressure is thereby built up in the pressure chamber 22—initiated by the force F which is exerted on the force input member and assisted by the motor-driven ball screw 26.

The motor is deactivated if the driver releases the brake pedal again. The entire arrangement can as a result return to its position which is shown in FIG. 1 under the action of a return spring, which is not shown, with the brake pressure in the pressure chamber 22 being reduced again.

Through the arrangement according to the invention it is possible to prevent the threaded spindle 28 from abruptly or jerkily displacing the pressure piston upon activation of the electric motor, which is not shown, after a play which is inherent in the system has been used up and thereby prevent an abrupt braking action, to which the driver is not accustomed, from being initiated and wear-promoting impacts from being exerted on the ball screw 26.

A second embodiment of the braking force generator according to the invention is represented in FIGS. 3 and 4. Only the differences with respect to the first embodiment according to FIGS. 1 and 2 are described in order to avoid repetition. In this respect the same reference numbers, although preceded by the FIG. “1”, are used for similar or equally acting components.

The second embodiment according to FIGS. 3 and 4 differs from the first embodiment according to FIGS. 1 and 2 through the connection between the transmission piston 138 and the pressure piston 120.

The intermediate member 148 is provided at its end which is on the right in FIG. 4 with a threaded portion and screwed by way of this into an internal thread at the left-hand end of the transmission piston 138. The intermediate member 148 comprises an integrally formed clamping ring 156, by way of which it clamps an impact sleeve 158, which is formed with the impact ring 140, against the left-hand end of the transmission piston 138. The Belleville spring assembly 146 is seated on the impact sleeve 158 and is supported on the left-hand side at the clamping ring 156 and on the right-hand side at the threaded spindle 128. The intermediate member 148 is formed at its left-hand end with a guide pin 160, on which a coupling sleeve 162, an intermediate element 164, which holds the latter, and a transmission member 166, which is screwed to the intermediate element 164, are guided.

A compression spring 168 is disposed between the clamping ring 156 and the impact sleeve 158, which spring biases the unit consisting of the coupling sleeve 162, the intermediate element 164 and the transmission member 166 into the starting position shown in FIGS. 3 and 4 relative to the intermediate member 148 such that a buffer clearance s₂ is obtained.

The effect of this buffer clearance s₂ is that, in the event of the brake pedal being depressed at a high speed and the force input member 112 consequently being displaced at a high speed to the left in FIG. 3, the intermediate member 148 firstly moves further into the unit consisting of the coupling sleeve 162, the intermediate element 164 and the transmission member 166, while the compression spring 168 is deformed, until the buffer clearance s₂ is finally used up and the intermediate member 148 comes by way of its impact shoulder 170 into direct working contact with the coupling sleeve 162. The period in which the buffer clearance s₂ is used up suffices as reaction time to activate the motor, which is not shown, and to displace the threaded spindle 128 of the ball screw 126. It is therefore possible to ensure that, even when the brake pedal is actuated at a high speed, braking force is generated via the ball screw 126 and the driver is not conscious of any unusually high resistance when actuating the brake pedal.

A third embodiment of the braking force generator according to the invention is represented in FIGS. 5 and 6. Only the differences with respect to the first and the second embodiment according to FIGS. 1 to 4 are described in order to avoid repetition. In this respect the same reference numbers, although preceded by the FIG. “2”, are used for similar or equally acting components.

The third embodiment according to FIGS. 5 and 6 basically differs from the second embodiment according to FIGS. 3 and 4 in that the compression spring 268 and the arrangement for providing the buffer clearance s₂ are disposed inside the threaded spindle 228.

The buffer clearance s₂ is provided between a contact disc 272 and a diametrical step 274 for this purpose. After overcoming the buffer clearance s₂, further transmission of force takes place via the impact sleeve 258, an intermediate disc 276, the lock nuts 250 and 252 and the intermediate member 248 to the pressure piston 220.

This third embodiment has the advantage that it can be more compact than the second embodiment which is shown in FIGS. 3 and 4.

A fourth embodiment of the braking force generator according to the invention is represented in FIGS. 7 and 8. Only the differences with respect to the first, the second and the third embodiment according to FIGS. 1 to 6 are described in order to avoid repetition. In this respect the same reference numbers, although preceded by the FIG. “3”, are used for similar or equally acting components.

The fourth embodiment according to FIGS. 7 and 8 basically differs from the second embodiment according to FIGS. 3 and 4 in that the arrangement for providing the coupling clearance s₁ is formed in a similar way to the first embodiment according to FIGS. 1 and 2 and that the arrangement for providing the buffer clearance s₂ is disposed between the force input member 312 and the transmission piston 338.

As regards the arrangement for providing the buffer clearance s₂, it is to be noted in particular that the force input member 312 co-operates with a push rod 380 which is held in an axial bore 382 formed in the transmission piston 338 and can be displaced along the axis A. A support sleeve 384 lies at the bottom of the axial bore 382, in which sleeve a pressure element 386, which is coupled to the push rod 380, is guided in a displaceable manner. A Belleville spring assembly 388 lies between the support sleeve 384 and the push rod 380. This Belleville spring assembly 388 can be compressed when the brake pedal is actuated at a high speed, while overcoming the buffer clearance s₂. This results in the effect, as described above with regard to the buffer clearance s₂, of providing sufficient reaction time for activating the braking force assistance.

1. Electromechanical brake pressure generator for a motor vehicle brake system with
a force input member, which is coupled to a brake pedal,
a housing and a pressure piston which can be displaced in the housing, wherein the pressure piston encloses, with the housing, a pressure chamber for generating a hydraulic brake pressure, and
a threaded spindle-threaded nut arrangement, one component of which can be displaced in order to displace the pressure piston relative to the housing, and the other component of which can be rotatably driven in the housing,
wherein the component of the threaded spindle-threaded nut arrangement which co-operates with the pressure piston can be displaced in order to displace the pressure piston according to a displacement of the force input member by rotatably driving the rotatably drivable component of the threaded spindle-threaded nut arrangement in order to generate a hydraulic brake pressure in the pressure chamber,
wherein the component of the threaded spindle-threaded nut arrangement which co-operates with the pressure piston and the pressure piston can only be workingly coupled together directly after overcoming a coupling clearance against the action of a spring force.

2. Electromechanical brake pressure generator according to claim 1, wherein a spring arrangement is provided between the component of the threaded spindle-threaded nut arrangement which co-operates with the pressure piston and the pressure piston, wherein the coupling clearance can be overcome against the spring force of the spring arrangement.

3. Electromechanical brake pressure generator according to claim 2, wherein the spring arrangement comprises a Belleville spring assembly.

4. Electromechanical brake pressure generator according to claim 1, wherein the component of the threaded spindle-threaded nut arrangement which co-operates with the pressure piston is formed with an impact shoulder which, after overcoming the coupling clearance, comes into working contact with the pressure piston or a construction element which is workingly coupled to the pressure piston.

5. Electromechanical brake pressure generator according to claim 1, wherein the component of the threaded spindle-threaded nut arrangement which co-operates with the pressure piston is constituted by the threaded spindle.

6. Electromechanical brake pressure generator according to claim 1, wherein the force input member is or can be coupled to the pressure piston in order to displace this.

7. Electromechanical brake pressure generator according to claim 1, wherein a buffer clearance is provided in the transmission path between the force input member and the pressure piston, wherein the force input member and the pressure piston can only be workingly coupled together after overcoming a buffer clearance.

8. Electromechanical brake pressure generator according to claim 7, wherein a buffer spring arrangement is associated with the buffer clearance, wherein the buffer clearance can be overcome against the spring force of the buffer spring arrangement.

9. Electromechanical brake pressure generator according to claim 1, wherein the force input member and the pressure piston can be coupled together via a transmission piston.

10. Electromechanical brake pressure generator according to claim 8, wherein the buffer clearance (s and the buffer spring arrangement are disposed between the force input member and the transmission piston.

11. Electromechanical brake pressure generator according to claim 8, wherein the buffer clearance and the buffer spring arrangement are disposed between transmission piston and the pressure piston.

12. Electromechanical brake pressure generator according to claim 1, wherein the component of the threaded spindle-threaded nut arrangement which co-operates with the pressure piston is guided so as to be secured against rotation relative to the housing, and that, in order to form the anti-rotation mechanism, a region of the component of the threaded spindle-threaded nut arrangement which co-operates with the pressure piston is provided with a cylindrical guide profile which co-operates with a complementary profile which is fixed relative to the housing, wherein the base area of the guide profile is of a form which is such that the component of the threaded spindle-threaded nut arrangement which co-operates with the pressure piston is supported at the complementary profile upon support forces being transmitted in a uniform distribution over the circumference of the cylindrical guide profile.

13. Electromechanical brake pressure generator according to claim 12, wherein the guide profile has a polygonal base area.

14. A motor vehicle brake system with an electromechanical brake pressure generator according to claim 1.
